(19) United States
(12) Patent Application Publication
(10) Pub. No.: US 2025/0116011 A1
(43) Pub. Date: Apr. 10, 2025

(54) FLUID CONTAINER AND ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/637,903

(22) Filed: Apr. 17, 2024

Related U.S. Application Data
(63) Continuation of application No. PCT/JP2023/036377, filed on Oct. 5, 2023.

(51) Int. Cl. C25B 9/60; B32B 1/00; B32B 3/30; B32B 15/01; H01M 8/0289

(52) U.S. Cl. CPC C25B 9/60; B32B 1/00; B32B 3/30; B32B 15/01; H01M 8/0289; B32B 2250/02; B32B 2307/7376; B32B 2439/00

(57) ABSTRACT

The present fluid container includes a first metallic member, a second metallic member, and an adherence part. Each of the first and second metallic members contains chromium. The adherence part is made of an oxide containing chromium as a primary component. The adherence part adheres the first metallic member and the second metallic member to each other. The adherence part includes a base portion and a protruding portion. The protruding portion protrudes from the base portion in a thickness direction.

### CROSS-REFERENCE TO RELATED APPLICATION

This is a continuation of PCT/JP2023/036377, filed Oct. 5, 2023, the entire contents of which are hereby incorporated by reference.

### TECHNICAL FIELD

The present invention relates to a fluid container and an electrochemical cell.

### BACKGROUND ART

Electrochemical cells such as electrolytic cells and fuel cells include a fluid container to supply a fluid to a cell body thereof. For example, a fluid container disclosed in JP2015-156352A includes a first inter-connector, a second inter-connector, a separator, a fuel electrode frame, and a glass seal.

The first inter-connector is connected to an air electrode of a fuel cell. The second inter-connector is connected to a fuel electrode-side electricity collecting layer of the fuel cell. The separator is connected to a solid electrolyte of the fuel cell and divides a channel for fuel gas and that for oxidant gas from each other. The fuel electrode frame is disposed between the separator and the second inter-connector. The glass seal adheres the first inter-connector and the separator to each other.

### SUMMARY OF THE INVENTION

### Technical Problems

In such a fluid container as described above, a first metallic member and a second metallic member are adhered to each other by an adherence part. It is concerned that, when cracking occurs in the adherence part, the adherence part is damaged or broken with advance of cracking.

It is an object of the present invention to provide a fluid container and an electrochemical cell, whereby damage or breakage of an adherence part can be inhibited.

### Solution to Problems

A fluid container according to a first aspect includes a first metallic member, a second metallic member, and an adherence part. Each of the first and second metallic members contain chromium. The adherence part is made of an oxide containing chromium as a primary component. The adherence part adheres the first and second metallic members to each other. The adherence part includes a base portion and a protruding portion. The protruding portion protrudes from the base portion in a thickness direction.

According to the configuration, the adherence part is interposed between the first and second metallic members; hence, a compression stress locally acts on a region provided with the protruding portion in the adherence part. As a result, even if cracking occurs in the adherence part, advancement of cracking can be inhibited in the region on which the compression stress locally acts, whereby damage or breakage of the adherence part can be inhibited.

A fluid container according to a second aspect relates to the fluid container according to the first aspect and is configured as follow. The protruding portion is made of a different material from the base portion.

A fluid container according to a third aspect relates to the fluid container according to the first aspect and is configured as follow. The protruding portion is made of an identical material to the base portion.

A fluid container according to a fourth aspect relates to the fluid container according to any of the first to third aspects and further includes an internal space through which a fluid flows. The adherence part annularly extends to enclose the internal space. The adherence part includes a plurality of the protruding portions. The plurality of protruding portions are aligned along an outer peripheral edge of the first metallic member.

A fluid container according to a fifth aspect relates to the fluid container according to any of the first to fourth aspects and further includes an internal space through which a fluid flows. The adherence part includes of a plurality of the protruding portions. The plurality of protruding portions are aligned from the internal space toward an outer peripheral edge of the first metallic member.

A fluid container according to a sixth aspect relates to the fluid container according to any of the first to fifth aspects and is configured as follow. A ratio (t2/t1) of a thickness (t2) of a thickest portion of the adherence part to a thickness (t1) of a thinnest portion of the adherence part is greater than or equal to 1.2.

A fluid container according to a seventh aspect relates to the fluid container according to any of the first to sixth aspects and further includes an internal space through which a fluid flows. The adherence part includes a large thickness portion thicker than an average thickness thereof. A ratio (L/L0) of a length (L) of the large thickness portion to a length (L0) of the adherence part in a direction oriented from the internal space to an outer peripheral edge of the first metallic member is less than or equal to 0.4.

A fluid container according to an eighth aspect relates to the fluid container according to any of the first to seventh aspects and further includes an internal space through which a fluid flows. The adherence part is a seal for sealing the internal space.

An electrochemical cell according to a ninth aspect includes the fluid container recited in any of the first to eighth aspects and a cell body disposed on the fluid container.

An electrochemical cell according to a tenth aspect relates to the electrochemical cell according to the ninth aspect and is configured as follows. The fluid container includes an internal space through which a fluid flows. The first metallic member includes a plurality of communicating holes continuing to the internal space. The cell body is disposed on the first metallic member to cover the plurality of communicating holes.

An electrochemical cell according to an eleventh aspect relates to the electrochemical cell according to the ninth aspect and is configured as follows. The fluid container includes an internal space through which a fluid flows. The second metallic member includes a plurality of communicating holes continuing to the internal space. The cell body is disposed on the second metallic member to cover the plurality of communicating holes.

### Advantageous Effects of Invention

According to the present invention, damage or breakage of an adherence part can be inhibited.

### BRIEF DESCRIPTION OF THE DRAWINGS

FIG. 1 is a plan view of an electrolytic cell.

FIG. 2 is a cross-sectional view of FIG. 1 taken along line II-II.

FIG. 3 is an enlarged cross-sectional view focusing on a first adherence part.

FIG. 4 is a plan view of a fluid container.

FIG. 5 is a diagram exemplifying a scanned image.

FIG. 6 is an enlarged cross-sectional view focusing on a first adherence part according to a modification.

### DESCRIPTION OF EMBODIMENTS

### <Electrolytic Cell>

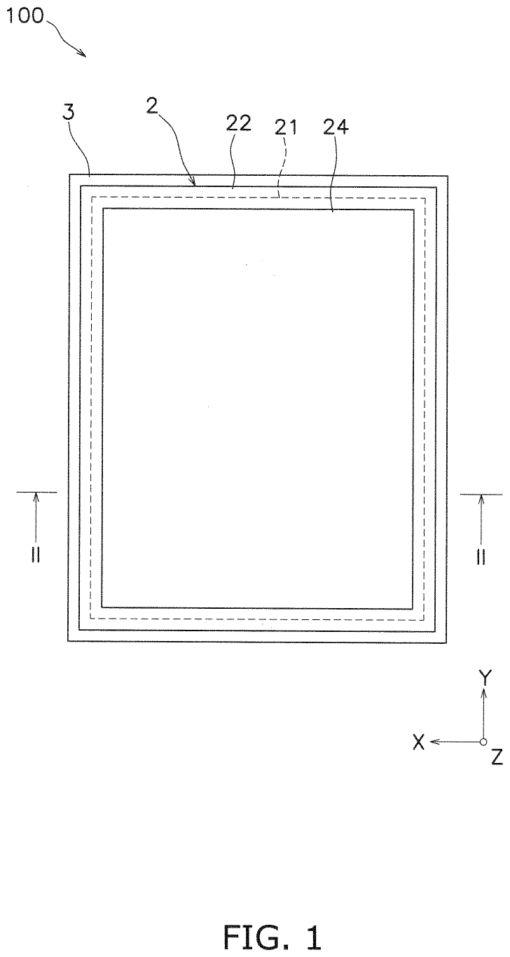

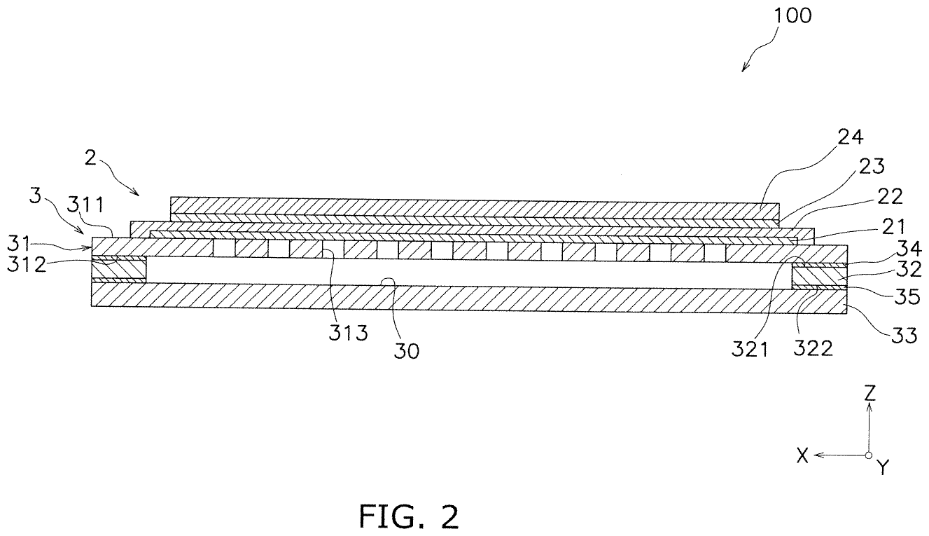

FIG. 1 is a plan view of an electrolytic cell 100. FIG. 2 is a cross-sectional view of FIG. 1 taken along line II-II.

As shown in FIG. 1, the electrolytic cell 100 (exemplary electrochemical cell) is made in shape of a plate extending in an X-axis direction and a Y-axis direction. In the present preferred embodiment, when seen in a plan view along a Z-axis direction perpendicular to both the X-axis and Y-axis directions, the electrolytic cell 100 is made in shape of a rectangle elongated in the Y-axis direction. However, the planar shape of the electrolytic cell 100 is not particularly limited to a specific shape, and hence, may be any shape other than the rectangle, such as a polygon, an ellipse, or a circle.

As shown in FIGS. 1 and 2, the electrolytic cell 100 includes a cell body 2 and a fluid container 3.

### <Cell Body>

The cell body 2 is disposed on the fluid container 3. The cell body 2 is supported by a metallic support 31 (to be described) composing part of the fluid container 3. The cell body 2 is disposed on the metallic support 31 to cover a plurality of communicating holes 313 (to be described). The cell body 2 includes a hydrogen electrode 21 (cathode), an electrolyte 22, a reaction preventing layer 23, and an oxygen electrode 24 (anode).

The hydrogen electrode 21, the electrolyte 22, the reaction preventing layer 23, and the oxygen electrode 24 are laminated in this order from the fluid container 3 side along the Z-axis direction. The hydrogen electrode 21, the electrolyte 22, and the oxygen electrode 24 are essential components; however, the reaction preventing layer 23 is a component provided on an arbitrary basis.

### <Hydrogen Electrode>

The hydrogen electrode 21 is disposed on a first principal surface 311 of the metallic support 31. The hydrogen electrode 21 is supplied with raw material gas from each of the communicating holes 313 of the metallic support 31. The raw material gas contains at least water vapor (H₂O). The hydrogen electrode 21 generates H₂ with electrolytic reactions.

When the raw material gas contains only H₂O, the hydrogen electrode 21 generates H₂ from the raw material gas by electrochemical reactions of water electrolysis expressed in the following formula (1).

—Hydrogen electrode 21: H₂0+2e⁻→H₂+O²⁻ (1)

When the raw material gas contains CO₂ in addition to H₂O, the hydrogen electrode 21 generates H₂, CO, and O²⁻ from the raw material gas by electrochemical reactions of co-electrolysis expressed in the following formulae (2), (3), and (4).

—Hydrogen electrode 21: CO₂+H₂O+4e⁻→CO+H₂+2O²⁻ (2)

Electrochemical reaction of H₂O: H₂O+2e⁻→H₂+O²⁻ (3)

Electrochemical reaction of CO₂: CO₂+2e⁻→CO+O²⁻ (4)

H₂ generated in the hydrogen electrode 21 flows out through each of the communicating holes 313 of the metallic support 31 to an internal space 30 (to be described).

The hydrogen electrode 21 is a porous body with electronic conductivity. The hydrogen electrode 21 contains nickel (Ni). In co-electrolysis, Ni functions not only functions as an electron transmitter but also functions as a thermal catalyst that maintains a gas composition appropriate for methanation, FR (Fischer-Tropsch) synthesis, and so forth by promoting thermal reactions between H₂ to be generated and CO₂ contained in the raw material gas. During operating the electrolytic cell 100, Ni contained in the hydrogen electrode 21 basically exists in a state of metal (Ni) but may exist in part in a state of nickel oxide (NiO).

The hydrogen electrode 21 may contain an ionic conductive material. For example, the following can be used as the ionic conductive material: one selected from the group of yttria-stabilized zirconia (YSZ), calcia-stabilized zirconia (CSZ), scandia-stabilized zirconia (ScSZ), gadolinium-doped ceria (GDC), samarium-doped ceria (SDC), (La, Sr)(Cr, Mn)O₃, (La, Sr)TiO₃, Sr₂(Fe, Mo)₂O₆, (La, Sr)VO₃, and (La, Sr)FeO₃, a mixed material obtained by a combination of two or more of the group, or so forth.

The hydrogen electrode 21 is not particularly limited in thickness, and hence, can be set to have a thickness of, for instance, greater than or equal to 1 μm and less than or equal to 100 μm. The hydrogen electrode 21 is not particularly limited in thermal expansion coefficient, and hence, can be set to have a thermal expansion coefficient of, for instance, greater than or equal to 12×10⁻⁶/° C. and less than or equal to 20×10⁻⁶/° C.

The hydrogen electrode 21 is not particularly limited in method of formation, and hence, can be formed by any of the methods such as firing, spray coating (thermal spraying, aerosol deposition, aerosol gas deposition, powder jet deposition, particle jet deposition, cold spraying, etc.), PVD (spattering, pulse laser deposition, etc.), and CVD.

### <Electrolyte>

The electrolyte 22 is formed on the hydrogen electrode 21. The electrolyte 22 is disposed between the hydrogen electrode 21 and the oxygen electrode 24. In the present preferred embodiment, the electrolyte 22 is connected to both the hydrogen electrode 21 and the reaction preventing layer 23, while being interposed therebetween.

The electrolyte 22 not only covers the hydrogen electrode 21 but also covers a region, exposed without being covered with the hydrogen electrode 21, on the first principal surface 311 of the metallic support 31.

The electrolyte 22 is a dense body with oxide ionic conductivity. The electrolyte 22 transmits O²⁻, generated in the hydrogen electrode 21, to the oxygen electrode 24 side. The electrolyte 22 is made of an oxide ionic conductive material. The electrolyte 22 can be made of, for instance, YSZ, GDC, ScSZ, SDC, LSGM (lanthanum gallate), or so forth but is preferably made of YSZ.

The electrolyte 22 is not particularly limited in thickness, and hence, can be set to have a thickness of, for instance, greater than or equal to 1 μm and less than or equal to 100 μm. The electrolyte 22 is not particularly limited in thermal expansion coefficient, and hence, can be set to have a thermal expansion coefficient of, for instance, greater than or equal to 10×10⁻⁶/° C. and less than or equal to 12×10⁻⁶/° C.

The electrolyte 22 is not particularly limited in method of formation, and hence, can be formed by any of the methods such as firing, spray coating, PVD, and CVD.

### <Reaction Preventing Layer>

The reaction preventing layer 23 is disposed between the electrolyte 22 and the oxygen electrode 24. The reaction preventing layer 23 is disposed on the opposite side of the side on which the hydrogen electrode 21 is disposed with reference to the electrolyte 22. The reaction preventing layer 23 inhibits a layer with high electric resistance from being formed by reactions between the element of which the electrolyte 22 is made and the element of which the oxygen electrode 24 is made.

The reaction preventing layer 23 is made of an oxide ionic conductive material. The reaction preventing layer 23 can be made of GDC, SDC, or so forth.

The reaction preventing layer 23 is not particularly limited in porosity, and hence, can be set to have a porosity of, for instance, greater than or equal to 0.1% and less than or equal to 50%. The reaction preventing layer 23 is not particularly limited in thickness, and hence, can be set to have a thickness of, for instance, greater than or equal to 1 μm and less than or equal to 50 μm.

The reaction preventing layer 23 is not particularly limited in method of formation, and hence, can be formed by any of the methods such as firing, spray coating, PVD, and CVD.

### <Oxygen Electrode>

The oxygen electrode 24 is disposed on the opposite side of the side on which the hydrogen electrode 21 is disposed with reference to the electrolyte 22. In the present preferred embodiment, the reaction preventing layer 23 is disposed between the electrolyte 22 and the oxygen electrode 24; hence, the oxygen electrode 24 is connected to the reaction preventing layer 23. When the reaction preventing layer 23 is not disposed between the electrolyte 22 and the oxygen electrode 24, the oxygen electrode 24 is connected to the electrolyte 22.

The oxygen electrode 24 generates O₂ from O²⁻ transmitted thereto from the hydrogen electrode 21 through the electrolyte 22 by chemical reactions expressed by the following formula (5).

Oxygen electrode 24: 2O²⁻→O₂+4e⁻ (5)

The oxygen electrode 24 is a porous body with oxide ionic conductivity and electronic conductivity. The oxygen electrode 24 can be made of, for instance, a composite material composed of an oxide ionic conductive material (GDC, etc.) and at least one selected from the group consisting of (La, Sr)(Co, Fe)O₃, (La, Sr)FeO₃, La(Ni, Fe)O₃, (La, Sr)CoO₃, and (Sm, Sr)CoO₃.

The oxygen electrode 24 is not particularly limited in porosity, and hence, can be set to have a porosity of, for instance, greater than or equal to 20% and less than or equal to 60%. The oxygen electrode 24 is not particularly limited in thickness, and hence, can be set to have a thickness of, for instance, greater than or equal to 1 μm and less than or equal to 100 μm.

The oxygen electrode 24 is not particularly limited in method of formation, and hence, can be formed by any of the methods such as firing, spray coating, PVD, and CVD.

### <Fluid Container>

As shown in FIG. 2, the fluid container 3 includes the internal space 30. The raw material gas to be supplied to the hydrogen electrode 21 and reducing gas (H₂ in the present preferred embodiment) to be generated in the hydrogen electrode 21 flow into the internal space 30. It should be noted that the raw material gas and the reducing gas are exemplary fluids of the present invention.

The fluid container 3 includes the metallic support 31 (exemplary first metallic member), a frame 32 (exemplary second metallic member), an inter-connector 33, a first adherence part 34 (exemplary adherence part), and a second adherence part 35. The internal space 30 is a space enclosed by the metallic support 31, the frame 32, the inter-connector 33, the first adherence part 34, and the second adherence part 35.

### <Metallic Support>

As shown in FIG. 2, the metallic support 31 supports the cell body 2. In the present preferred embodiment, the metallic support 31 is made in shape of a plate. Insomuch as the cell body 2 can be supported by the metallic support 31, the metallic support 31 is not particularly limited in thickness, and hence, can be set to have a thickness of, for instance, greater than or equal to 0.1 mm and less than or equal to 2.0 mm.

The metallic support 31 includes the plural communicating holes 313, the first principal surface 311, and a second principal surface 312.

Each communicating hole 313 penetrates the metallic support 31 from the first principal surface 311 to the second principal surface 312. Each communicating hole 313 is opened on each of the first and second principal surfaces 311 and 312. Each communicating hole 313 is covered with the cell body 2. Specifically, the first principal surface 311-side opening of each communicating hole 313 is covered with the hydrogen electrode 21. The second principal surface 312-side opening of each communicating hole 313 continues to the internal space 30.

Each communicating hole 313 can be formed by machining processing (e.g., punching), laser processing, chemical processing (e.g., etching), or so forth.

In the present preferred embodiment, each communicating hole 313 is shaped straight along the Z-axis direction. However, each communicating hole 313 may slant with respect to the Z-axis direction; besides or alternatively, each communication hole 313 may not be shaped straight. Besides or alternatively, the communicating holes 313 may continue to each other.

The first principal surface 311 is provided on the opposite side of the second principal surface 312. The cell body 2 is disposed on the first principal surface 311. The frame 32 is joined to the second principal surface 312 through the first adherence part 34.

The metallic support 31 is made of an alloy containing Cr (Chromium). Fe—Cr-based alloy steel (stainless steel, etc.), Ni—Cr-based alloy steel, or so forth can be exemplified as the alloy herein described. The metallic support 31 is not particularly limited in content rate of Cr, and hence, can be set to contain Cr at a content rate of greater than or equal to 4 mass % and less than or equal to 30 mass %.

The metallic support 31 may contain Ti (Titanium) and Zr (Zirconium). The metallic support 31 is not particularly limited in content rate of Ti, and hence, can be set to contain Ti at a content rate of greater than or equal to 0.01 mol % and less than or equal to 1.0 mol %. The metallic support 31 is not particularly limited in content rate of Zr, and hence, can be set to contain Zr at a content rate of greater than or equal to 0.01 mol % and less than or equal to 0.4 mol %. The metallic support 31 may contain Ti in the form of TiO₂ (titania) and may contain Zr in the form of ZrO₂ (zirconia).

### <Frame>

The frame 32 is a spacer for forming the internal space 30. The frame 12 is annularly shaped in a plan view (seen in the Z-axis direction). The frame 32 is joined to the metallic support 31 through the first adherence part 34, while being joined to the inter-connector 33 through the second adherence part 35. The frame 32 is not particularly limited in thickness, and hence, can be set to have a thickness of, for instance, greater than or equal to 0.1 mm and less than or equal to 2.0 mm.

The frame 32 includes a first principal surface 321 and a second principal surface 322. The first principal surface 321 of the frame 32 is a surface facing the metallic support 31. The second principal surface 322 of the frame 32 is a surface facing the inter-connector 33.

The frame 32 is made of an alloy containing Cr. Fe—Cr-based alloy steel, Ni—Cr-based alloy steel, or so forth can be exemplified as the alloy herein described. The frame 32 is not particularly limited in content rate of Cr, and hence, can be set to contain Cr at a content rate of greater than or equal to 4 mass % and less than or equal to 30 mass %. The frame 32 may be identical in composition to or different in composition from the metallic support 31.

### <Inter-Connector>

The inter-connector 33 is disposed on the opposite side of the side on which the metallic support 31 is disposed with reference to the frame 32. The inter-connector 33 is a member for electrically connecting the electrolytic cell 100 to either an external power source or another electrolytic cell.

The inter-connector 33 is made in shape of a plate. The inter-connector 33 is joined to the frame 32 through the second adherence part 35. The inter-connector 33 is not particularly limited in thickness, and hence, can be set to have a thickness of, for instance, greater than or equal to 0.1 mm and less than or equal to 2.0 mm.

The inter-connector 33 is made of an alloy containing Cr. Fe—Cr-based alloy steel, Ni—Cr-based alloy steel, or so forth can be exemplified as the alloy herein described. The inter-connector 33 is not particularly limited in content rate of Cr, and hence, can be set to contain Cr at a content rate of greater than or equal to 4 mass % and less than or equal to 30 mass %. The inter-connector 33 may be identical in composition to or different in composition from the metallic support 31. The inter-connector 33 may be identical in composition to or different in composition from the frame 32.

### <First Adherence Part>

The first adherence part 34 is disposed between the metallic support 31 and the frame 32. The first adherence part 34 adheres the metallic support 31 and the frame 32 to each other. When described in detail, the first adherence part 34 is joined to each of the metallic support 31 and the frame 32.

The first adherence part 34 seals a gap between the metallic support 31 and the frame 32. Accordingly, the raw material gas to be supplied to the hydrogen electrode 21 and the reducing gas to be generated in the hydrogen electrode 21 can be prevented from leaking out through the gap between the metallic support 31 and the frame 32.

The first adherence part 34 is disposed between the metallic support 31 and the frame 32. The first adherence part 34 is interposed between the metallic support 31 and the frame 32. The first adherence part 34 annularly extends to enclose the internal space 30. The first adherence part 34 functions as a seal for sealing the internal space 30. In other words, the first adherence part 34 annularly extends in a continuous manner.

The first adherence part 34 is made of an oxide containing Cr as a primary component (hereinafter abbreviated as “Cr oxide”). Accordingly, during manufacturing or operating the electrolytic cell 100, Cr can be inhibited from diffusing from the metallic support 31 and the frame 32 to the first adherence part 34. Besides, even if Cr diffuses from the metallic support 31 and the frame 32 to the first adherence part 34, the diffused Cr is not so much as affecting the composition of the first adherence part 34; hence, deterioration in strength of the first adherence part 34 can be inhibited as well. Furthermore, the metallic support 31, the frame 32, and the first adherence part 34 contain Cr in common, whereby adherence property can be enhanced among the metallic support 31, the frame 32, and the first adherence part 34. Therefore, adherence property of the metallic support 31 and the frame 32 can be maintained over a long period of time.

It should be noted that in the present preferred embodiment, “the Cr oxide, of which the first adherence part 34 is made, contains Cr as the primary component” means that Cr is the highest in content rate among metallic elements of the Cr oxide when the composition of the Cr oxide is analyzed by an energy dispersive spectrometer (EDS). The Cr oxide is not particularly limited in content rate of Cr among the metallic elements, and hence, can be set to contain Cr at a content rate of, for instance, greater than or equal to 20 mol % and less than or equal to 100 mol %.

The Cr oxide, of which the first adherence part 34 is made, preferably contains Cr among the metallic elements thereof at a content rate of greater than or equal to 50 mol %. Accordingly, Cr contained in the metallic support 31 and the frame 32 can be remarkably inhibited from being diffused to the first adherence part 34.

The Cr oxide, of which the first adherence part 34 is made, is preferably composed of at least either chromium oxide or chromium manganese oxide. The oxides herein described have properties that Cr is especially unlikely to diffuse; hence, the first adherence part 34 can be thereby enhanced in durability.

Cr₂O₃ or so forth can be exemplified as the chromium oxide. MnCr₂O₄ (spinel), Mn_{1.5}Cr_{1.5}O₄ (spinel), or so forth can be exemplified as the chromium manganese oxide.

The Cr oxide, of which the first adherence part 34 is made, is preferably crystalline. Because of this, even if the electrolytic cell 100 is operated for a long period of time, it is made possible to avoid occurrence of such a situation that the Cr oxide transitions from a non-crystalline phase to a crystalline phase, whereby the first adherence part 34 is undesirably damaged or broken.

The Cr oxide, of which the first adherence part 34 is made, preferably has either a spinel crystal structure or a corundum crystal structure. The crystal structures herein described are high in symmetry; hence, the first adherence part 34 can be thereby enhanced in endurance against thermal stress.

The first adherence part 34 can be formed by applying a paste containing the Cr oxide onto at least either the surface of the metallic support 31 or that of the frame 32, and then, by conducting a thermal treatment in a state that the metallic support 31 and the frame 32 are closely contacted to each other. Conditions for the thermal treatment can be arbitrarily set but the following can be set as exemplary conditions for the thermal treatment: a temperature of greater than or equal to 600° C. and less than or equal to 1100° C. and a duration of greater than or equal to 0.5 hours and less than or equal to 24 hours.

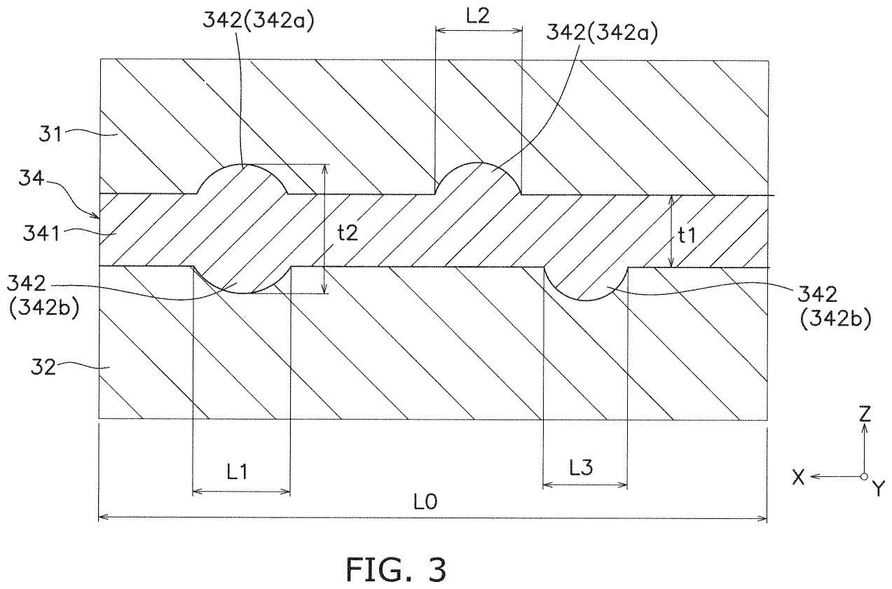

FIG. 3 is an enlarged cross-sectional view focusing on the first adherence part 34. As shown in FIG. 3, the first adherence part 34 includes a base portion 341 and a plurality of protruding portions 342.

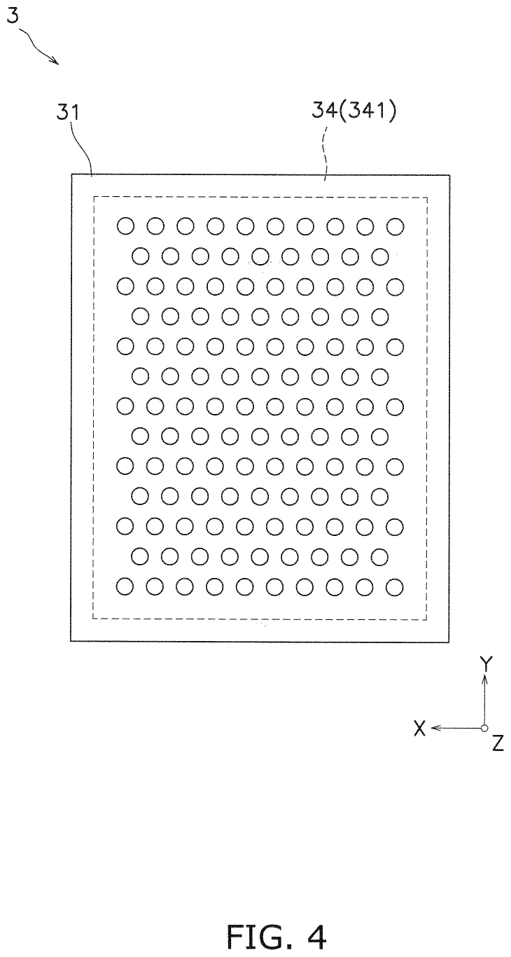

FIG. 4 is a plan view of the fluid container 3. As shown in FIG. 4, in the plan view (seen in the Z-axis direction), the first adherence part 34 includes four straight portions. In other words, in the plan view, the base portion 341 includes four straight portions. When described in detail, the base portion 341 includes a pair of straight portions extending in the X-axis direction and a pair of straight portions extending in the Y-axis direction. In the plan view, the base portion 341 extends in a rectangular shape. In other words, the base portion 341 annularly extends in a continuous manner to enclose the internal space 30.

As shown in FIG. 3, each protruding portion 342 is configured to protrude from the base portion 341 in the thickness direction (the Z-axis direction) of the first adherence part 34. When described in detail, the plural protruding portions 342 are composed of a plurality of first protruding portions 342a and a plurality of second protruding portions 342b. Each first protruding portion 342a protrudes from the base portion 341 toward the metallic support 31 (upward in FIG. 3). Each second protruding portion 342b protrudes from the base portion 341 toward the frame 32 (downward in FIG. 3). The first protruding portions 342a and the second protruding portions 342b may or may not overlap with each other in the plan view.

The protruding portions 342 are aligned along the outer peripheral edge of the metallic support 31. In other words, the protruding portions 342 are aligned along the extending direction of the first adherence part 34. Because of this, the protruding portions 342 are annularly aligned in the plan view. Besides, the protruding portions 342 are aligned from the internal space 30 toward the outer peripheral edge of the metallic support 31.

A ratio (t2/t1) of the thickness (t2) of the thickest portion of the first adherence part 34 to the thickness (t1) of the thinnest portion of the first adherence part 34 is preferably set to be greater than or equal to 1.2. It should be noted that the thickness (t1) of the thinnest portion and the thickness (t2) of the thickest portion in the first adherence part 34 are measured based on a plurality of scanned (photographed) images. Specifically, the first adherence part 34 is cut along a direction oriented from the internal space 30 to the outer peripheral edge of the metallic support 31 to create such a cross section thereof as shown in FIG. 3. Then, the cross section is scanned (photographed) by a scanning electron microscopy (SEM) at a 1000-fold magnification to obtain a plurality of scanned images. Subsequently, in each scanned image, the thickness of the thinnest portion in the first adherence part 34 is measured as the thickness t1 of the thinnest portion. Likewise, in each scanned image, the thickness of the thickest portion in the first adherence part 34 is measured as the thickness t2 of the thickest portion. Thereafter, in each scanned image, the ratio (t2/t2) of the thickness (t2) of the thickest portion to the thickness (t1) of the thinnest portion in the first adherence part 34 is calculated. In each scanned image, the ratio (t2/t1) is preferably greater than or equal to 1.2 but may be arbitrary insomuch as the ratio (t2/t2) is greater than or equal to 1.2 in at least any of the scanned images.

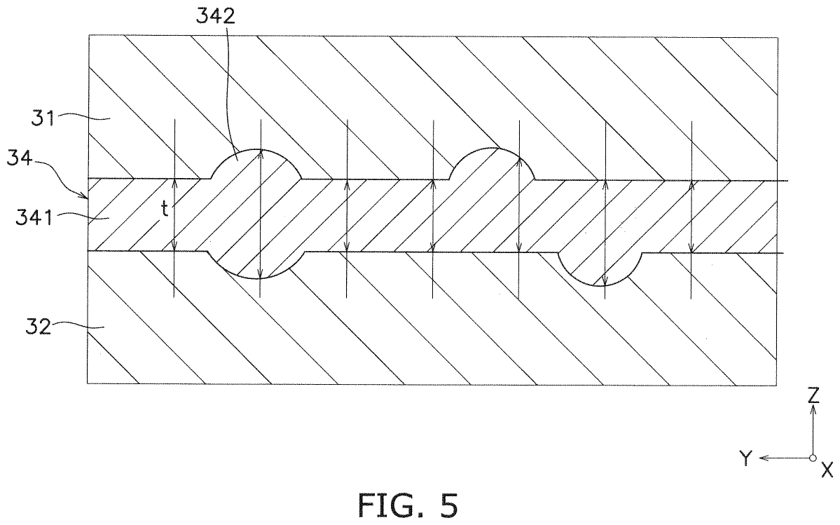

The first adherence part 34 is not particularly limited in average thickness (t₀), and hence, for instance, is greater than or equal to 1 μm and less than or equal to 100 μm. The average thickness to of the first adherence part 34 can be measured based on each of the scanned images described above. Specifically, as shown in FIG. 5, values of the thickness (t) of the first adherence part 34 are measured at measurement points set to equally divide each scanned image into eight sections in the direction oriented from the internal space 30 to the outer peripheral edge of the metallic support 31, whereby an average of the measured values can be set as the average thickness of the first adherence part 34. Overall, an average of all the measured values measured in the scanned images is set as the average thickness to of the first adherence part 34. A ratio (t3/t0) of the thickness (t3) of the metallic support 31 to the thickness (to) of the first adherence part 34 can be set to be, for instance, less than or equal to 500.

As shown in FIG. 3, a ratio (L/L0) of the length (L) of a large thickness portion of the first adherence part 34 to the length (L0) of the first adherence part 34 in the direction oriented from the internal space 30 to the outer peripheral edge of the metallic support 31 can be set to be less than or equal to 0.4. “The large thickness portion of the first adherence part 34” herein refers to a portion thicker than the average thickness to of the first adherence part 34. For example, when the first adherence part 34 is shaped as shown in FIG. 3, portions provided with the protruding portions 342 correspond to the large thickness portions; hence, the first adherence part 34 includes a plurality of large thickness portions. In such a configuration with the plural large thickness portions as herein described, “the length L of the large thickness portion” is calculated as a sum of the lengths of the large thickness portions. For example, when the first adherence part 34 is shaped as shown in FIG. 3, “the length L of the large thickness portion” is calculated as a sum of L1, L2, and L3.

In the first adherence part 34, a region provided with the protruding portions 342 is made thick. Here, the protruding portions 342 correspond to portions thicker than the average thickness to of the first adherence part 34 by greater than or equal to 20%.

The base portion 341 and the protruding portions 342 are made of the material described above as the material, of which the first adherence part 34 is made. The protruding portions 342 can be made of a material different from that of the base portion 341. For example, when the base portion 341 is made of chromium oxide, the protruding portions 342 are made of chromium-manganese oxide. It should be noted that the protruding portions 342 may be made of a material identical to that of the base portion 341.

### <Second Adherence Part>

As shown in FIG. 2, the second adherence part 35 is disposed between the frame 32 and the inter-connector 33. The second adherence part 35 adheres the frame 32 and the inter-connector 33 to each other. When described in detail, the second adherence part 35 is joined to each of the frame 32 and the inter-connector 33.

The second adherence part 35 seals a gap between the frame 32 and the inter-connector 33. Accordingly, the raw material gas to be supplied to the hydrogen electrode 21 and the reducing gas to be generated in the hydrogen electrode 21 are prevented from being leaked out through the gap between the frame 32 and the inter-connector 33.

The second adherence part 35 is substantially identical in configuration to the first adherence part 34 described above; hence, in the present preferred embodiment, explanation will be omitted for the configuration of the second adherence part 35.

### <Manufacturing Method>

A method of manufacturing the first adherence part 34 will be hereinafter explained. First, the metallic support 31 is processed by stamping, whereby recessed portions are formed in a region, adhered to the first adherence part 34, on the second principal surface 312 of the metallic support 31. It should be noted that the recessed portions may be formed on the second principal surface 312 of the metallic support 31 by cutting, etching, laser abrasion, or so forth.

Likewise, the frame 32 is processed by stamping, whereby recessed portions are formed in a region, adhered to the first adherence part 34, on the first principal surface 321 of the frame 32.

Then, the first adherence part 34 can be formed by applying a paste containing crystalline metallic oxide to at least either the surface of the metallic support 31 or that of the frame 32, and then, by conducting a thermal treatment in a state that the metallic support 31 and the frame 32 are closely contacted to each other. Conditions for the thermal treatment can be arbitrarily set. For example, the following can be set as the conditions for the thermal treatment: a temperature of greater than or equal to 600° C. and less than or equal to 1100° C. and a duration of greater than or equal to 0.5 hours and less than or equal to 24 hours.

### Modifications of Preferred Embodiment

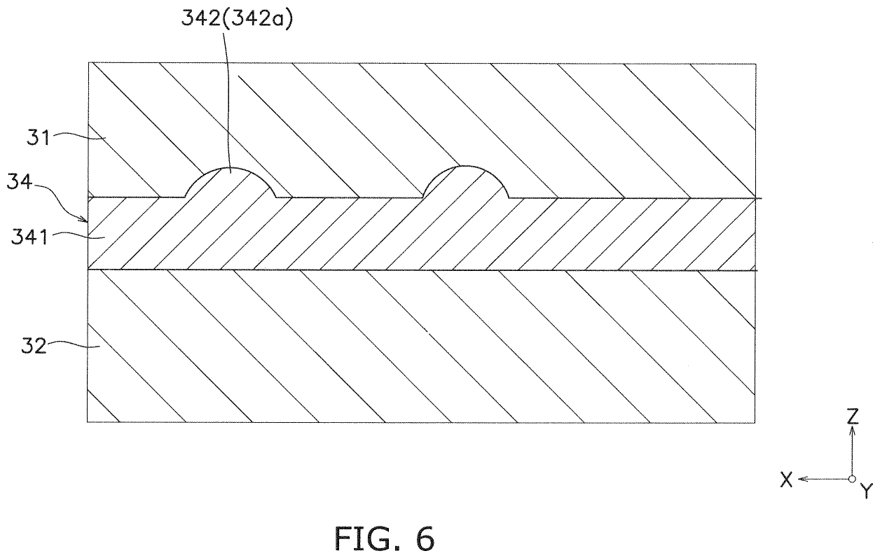

One preferred embodiment of the present invention has been explained above. However, the present invention is not limited to this, and a variety of changes can be made without departing from the gist of the present invention.
(a) In the preferred embodiment described above, the frame 32 and the inter-connector 33 are provided as separate members but may be provided as an integrated member. In this case, the fluid container 3 does not include the second adherence part 35.
(b) In the preferred embodiment described above, the metallic support 31 and the frame 32 are provided as separate members but may be provided as an integrated member. In this case, the fluid container 3 does not include the first adherence part 34.
(c) In the preferred embodiment described above, the metallic support 31 is exemplified as the first metallic member, whereas the frame 32 is exemplified as the second metallic member; however, the fluid container 3 is not limited in configuration to this. For example, the frame 32 may be exemplified as the first metallic member, whereas the metallic support 31 may be exemplified as the second metallic member.
(d) In the preferred embodiment described above, the first adherence part 34 is provided with the plural protruding portions 342 over the entire circumference thereof but is not limited in configuration to this. For example, among the four straight portions included in the first adherence part 34, only one straight portion may be provided with the plural protruding portions 342. When described in detail, among the four straight portions, the one, in which cracking is likely to occur, may be provided with the plural protruding portions 342. Besides, as to the straight portion provided with the plural protruding portions 342, the entirety thereof is not required to be provided therewith and only part thereof may be provided therewith.
(e) In the preferred embodiment described above, the plural protruding portions 342 are composed of the first protruding portions 342a and the second protruding portions 342b but are not limited in configuration to this. For example, as shown in FIG. 6, the plural protruding portions 342 may be composed of only the first protruding portions 342a. Contrarily, the plural protruding portions 342 may be composed of only the second protruding portions 342b. Besides, in the preferred embodiment described above, the first adherence part 34 includes the plural protruding portions 342, but alternatively, may include one protruding portion 342.
(f) In the preferred embodiment described above, the electrochemical cell is exemplified by the electrolytic cell but is not limited thereto. The electrochemical cell is a generic term for referring to an element for changing electric energy into chemical energy, in which a pair of electrodes is disposed to generate an electromotive force from entire oxidoreduction reactions, and an element for changing chemical energy into electric energy. Therefore, a fuel cell, in which oxide ions or protons act as carriers, is considered as the electrochemical cell.
(g) The preferred embodiment described above has been explained as the embodiment that the fluid container according to the present invention is applied to the electrochemical cell; however, the fluid container is usable for a variety of applications. The fluid container is applicable to, for instance, a reactor for methanation to synthesize methane from hydrogen and carbon dioxide.

### REFERENCE SIGNS LIST

2: Cell body
3: Fluid container
30: Internal space
31: Metallic support
313: Communicating hole
32: Frame
34: First adherence part
341: Base portion
342: Protruding portion
100: Electrolytic cell

1. A fluid container comprising:
a first metallic member containing chromium;
a second metallic member containing chromium; and
an adherence part made of an oxide containing chromium as a primary component, the adherence part adhering the first and second metallic members to each other, wherein
the adherence part includes a base portion and a protruding portion protruding from the base portion in a thickness direction.

2. The fluid container according to claim 1, wherein the protruding portion is made of a different material from the base portion.

3. The fluid container according to claim 1, wherein the protruding portion is made of an identical material to the base portion.

4. The fluid container according to claim 1, further comprising:
an internal space through which a fluid flows, wherein
the adherence part annularly extends to enclose the internal space,
the adherence part includes a plurality of the protruding portions, and
the plurality of protruding portions are aligned along an outer peripheral edge of the first metallic member.

5. The fluid container according to claim 1, further comprising:
an internal space through which a fluid flows, wherein
the adherence part includes a plurality of the protruding portions, and
the plurality of protruding portions are aligned from the internal space toward an outer peripheral edge of the first metallic member.

6. The fluid container according to claim 1, wherein a ratio (t2/t1) of a thickness (t2) of a thickest portion of the adherence part to a thickness (t1) of a thinnest portion of the adherence part is greater than or equal to 1.2.

7. The fluid container according to claim 1, further comprising:
an internal space through which a fluid flows, wherein
the adherence part includes a large thickness portion thicker than an average thickness thereof, and
a ratio (L/L0) of a length (L) of the large thickness portion to a length (L0) of the adherence part in a direction oriented from the internal space to an outer peripheral edge of the first metallic member is less than or equal to 0.4.

8. The fluid container according to claim 1, further comprising:
an internal space through which a fluid flows, wherein
the adherence part is a seal for sealing the internal space.

9. An electrochemical cell comprising:
the fluid container recited in claim 1; and
a cell body disposed on the fluid container.

10. The electrochemical cell according to claim 9, wherein
the fluid container includes an internal space through which a fluid flows,
the first metallic member includes a plurality of communicating holes continuing to the internal space, and
the cell body is disposed on the first metallic member to cover the plurality of communicating holes.

11. The electrochemical cell according to claim 9, wherein
the fluid container includes an internal space through which a fluid flows,
the second metallic member includes a plurality of communicating holes continuing to the internal space, and
the cell body is disposed on the second metallic member to cover the plurality of communicating holes.
